(19) United States
(12) Patent Application Publication
(10) Pub. No.: US 2011/0278798 A1
(43) Pub. Date: Nov. 17, 2011

(54) METHOD AND SYSTEM FOR CONTROLLING CONTACT BETWEEN SEAL COMPONENTS

(76) Inventor: Nicholas Gregory Zupp, Grove City, PA (US)

(21) Appl. No.: 12/781,246

(22) Filed: May 17, 2010

(51) Int. Cl. F16J 15/34; F02G 1/043

(52) U.S. Cl. 277/306; 277/360; 60/527; 60/529

(57) ABSTRACT

A temperature responsive control system, the system including a first seal, a second seal abutting the first seal, and a thermally reactive element in contact with the first seal and/or the second seal wherein the thermally reactive element constricts to displace at least one of said first and second seals, for reducing a degree of contact pressure between the first and second seals from a first, higher level of contact pressure to a second, lower level of contact pressure, when a temperature of the first seal and/or the second seal increases to a level to activate the thermally reactive element to constrict. A water pump seal pressure system with abutting seals and a method for managing the contact between abutting seals in a system are also disclosed.

### BACKGROUND OF THE INVENTION

Exemplary embodiments generally relate to seal components and, more particularly, to controlling contact between abutting seals to prevent leakage of fluid, to minimize or eliminate damage to the seal components and/or purge non-dissolved gasses.

A seal component is a device which may be used in a system or a mechanism for preventing leakage (e.g., in a plumbing system), containing pressure, or excluding contamination. For example, a water pump system generally utilizes seal components, such as face seal components, to prevent leakage of a coolant. More specifically, a face seal component is a device where a sealing surface is normal to the axis of the seal. Face seals are typically used in dynamic applications and to prevent leakage. In a water pump system, face seal components are often located in a groove or cavity on a flange. Two face seals abut against each other, with a first seal being a rotating seal which rotates against a second, stationary seal.

The rotating seal component and the stationary seal components are prone to wear and often exhibit problems in maintaining a secure, leak-proof seal in a water pump function. Although these materials have historically been part of pump designs, they have not been able to meet the extended life expectations of pumps in modern mechanical systems. Seal failure is typically caused by failure of the rotating seal component, which is associated with a drive shaft, spinning the rotational face against the stationary face in the water pump. In many systems which use a fluid as a coolant for cooling the system, for example, in systems containing water pumps as in engine cooling systems, coolant levels may drop below an acceptable level to cool the seal components. Additionally, a seal may be thermally isolated from the system media, or fluid, by a non-dissolved gas. Currently, most of the gasses are released through an overflow tank. However, a small portion of gasses may become trapped in a seal area and cause damage to the seals.

When coolant levels are insufficient to cool the seal components, or sufficient non-dissolved gasses are present, the rotating seal component used to prevent leakage around the drive shaft may dry out and create increased friction as it rotates against the stationary seal component. This process, also known as “dry running,” causes heat which is generated by the seal components rubbing together to increase the temperature of the seal components and the surrounding elements. As a result, the seal components are invariably damaged or destroyed.

Previous attempts to prevent the wear of seal components in such cases have resulted in limited success. For example, attempts to impregnate a consumable lubricant on the seal components in order to reduce the wear of the face seal have failed to solve the problem because, as the lubricant disappears, the face seal wears down and eventually becomes destroyed. Thus, manufacturers and owners of devices that utilize abutting seal components would benefit from a system and method that increases the life expectancy of abutting seal components and/or purge non-dissolved gasses from a system.

### BRIEF DESCRIPTION OF THE INVENTION

Embodiments of the present invention relate to a system and method for providing for a temperature responsive control system to manage contact between abutting seals.

The system comprises a first seal, a second seal abutting the first seal, and a thermally reactive element in contact with the first seal and/or the second seal. The thermally reactive element constricts to displace at least one of the first and second seals, for reducing a degree (degree refers to an extent or magnitude and not a temperature of degree) of contact pressure between the first and second seals from a first, higher level of contact pressure to a second, lower level of contact pressure, when a temperature of the first seal and/or the second seal increases to a level to activate the thermally reactive element to constrict.

Another exemplary system comprises a rotating face seal configured to provide a rotating seal for a rotating unit, a stationary face seal configured to provide a stationary seal for a stationary unit, wherein the rotating face seal and stationary face seal abut one another, and a thermally reactive element in contact with the rotating face seal and/or the stationary face seal. The thermally reactive element constricts to displace at least one of the rotating face seal and stationary face seal, for reducing a degree of contact pressure between the rotating face seal and stationary face seal from a first, higher level of contact pressure to a second, lower level of contact pressure, when a temperature of the rotating seal and/or the stationary seal increases to a level to activate the thermally reactive element to constrict.

The method comprises providing a rotating face seal configured to provide a rotating seal for a rotating unit and a stationary face seal configured to provide a stationary seal for a stationary unit wherein the rotating face seal and the stationary face seal abut one another, providing a thermally reactive element in contact with the stationary face seal or the rotating face seal, and constricting the thermally reactive element to displace the seals from abutting when a temperature of the rotating face seal and/or the stationary face seal increases to a level that activates the thermally reactive element to constrict. The method also comprises constricting the thermally reactive element to displace at least one of the rotating face seal and the stationary face seal, for reducing a degree of contact pressure between the rotating face seal and the stationary face seal from a first, higher level of contact pressure to a second, lower level of contact pressure, when a temperature of the rotating face seal and/or the stationary face seal increases to a level to activate the thermally reactive element to constrict.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 depicts an exemplary embodiment of a temperature responsive control system between two seal members;

FIG. 2 depicts two other exemplary embodiments of a temperature responsive control system between two seal members; and

FIG. 3 depicts an exemplary embodiment of a method for managing the contact between abutting seals in a system.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts. Exemplary embodiments of the invention solve problems in the art by providing a temperature responsive control system and method to manage contact between abutting seals.

Described herein is a water pump having a water pump seal pressure system as may be used in powered vehicle, such as but not limited to a locomotive. However, those skilled in the art will readily recognize that exemplary embodiments described herein are not limited to water pumps or to locomotives. For example, exemplary embodiments of the invention may be used in other powered systems, such as but not limited to stationary powered systems, off-highway vehicles, over road transportation systems, etc. Additionally, exemplary embodiments of the invention may be used in other subsystems, instead of just water pumps, where two seals are abutted against each other to create a leak-proof seal.

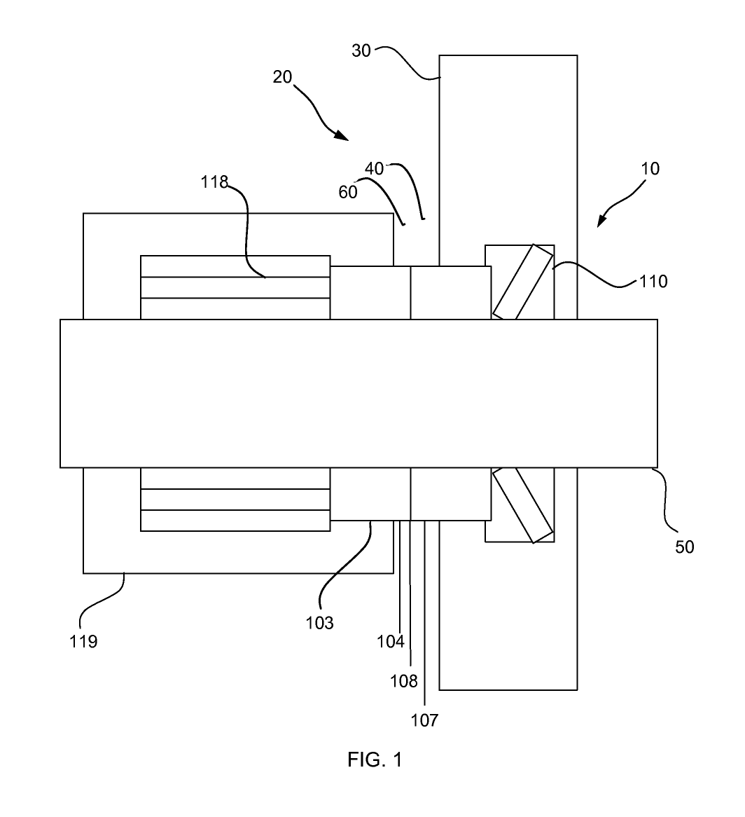

FIG. 1 depicts an embodiment of a temperature responsive pressure control system 100 between two seal members. In general, there is a stationary side 10 and a rotating side 20 within a water pump. The stationary side 10 may comprise a flange 30 and a stationary seal 107 that has a face seal 108 embedded in the flange 30, around an opening 40, or hole, through which a rotating shaft 50 is provided. The stationary seal 107 (having the face seal 108) is sealed to the flange 30, and is axially moveable between at least first and second positions. A rotating seal 103 having a face seal 104, typically made from the same material as the stationary seal, is fixed around the rotating shaft 50 and rotates with the rotating shaft 50. Behind the rotating seal 103 is a spring device 118, or spring element, that presses the rotating seal 103 against the stationary seal 107. The combination of the force of the spring device 118 and the face seals 104, 108 of both the rotating seal 103 and stationary seal 107 prevents any significant water from penetrating between the face seals 104, 108 and leaking when the pump is stationary. When the rotating shaft 50 rotates, prevention of any leakage is aided by a build up of heat at the face seals 104, 108 which will vaporize the water that penetrates between the face seals 104, 108. The face seals 104, 108 generally operate at a temperature somewhat above the boiling point of the water surrounding the seals 103, 107.

As further illustrated in FIG. 1, the rotating seal 103 and the stationary seal 107 abut one another, with each face seal 104, 108 actually abutting each other, to prevent leakage of fluid. A thermally reactive element 110 is also provided which is in contact with the stationary seal 107. The thermally reactive element 110 constricts and expands as a function of a change in temperature of the stationary seal 107, displacing the stationary seal 107 from the abutted rotating seal 103. The thermally reactive element 110 expands to a predefined dimension. The predefined dimension may be based on the physical make up of the thermally reactive element 110. In an embodiment, the thermally reactive element comprises an annular body, wherein when expanded the annular body is generally frustoconical, and when constricted the annular body is generally flat or washer-like, or at least is frustoconical but with a lower effective height.

By implementing a thermally reactive element, for example, a bi-metallic element 110, the thermally reactive element acts to displace the seals 103, 107 and reduce the contact between them, depending on temperature conditions. Thus, when the thermally reactive element constricts, this reduces the contact pressure between the stationary seal and the rotating seal, and the generation of heat is lessened. As a result, across an entire range of levels of seal contact, fluid leakage or passage of fluid between the seals 103, 107 is prevented, or at least reduced. The bi-metallic element 110 is a metallic material made from two metals with different characteristics of thermal expansion. The bi-metallic element 110 will constrict when a temperature exceeds a predefined temperature, which is determined from the materials used to form the bi-metallic element 110. In another exemplary embodiment, the bi-metallic element 110 will expand to return to its pre-constricted dimension when temperature of the bi-metallic element 110 is below the predefined temperature or another temperature which will automatically result in the bi-metallic element expanding to its original dimension.

When either of the seals 103, 107 reach a predetermined temperature, the thermally reactive element 110 moves to relieve and/or reduce contact pressure between the seals 103, 107, to allow at least one of the seals 103, 107 to be displaced from the abutting seal 103, 107. The seals 103, 107 and the bi-metallic element 112 are connected in such configuration that the temperature of the seals 103, 107 is communicated to the bi-metallic element 110 to effect constriction of the bi-metallic element 110. As the temperature of the bi-metallic element 110 changes, the bi-metallic element 110 constricts a certain amount, a characteristic used to control a position of a seals as a function of temperature.

Additionally, when the thermally reactive element constricts, the contact pressure between the stationary seal and the rotating seal is reduced and/or removed, allowing a non-dissolved gas that is trapped to exit between the seals. More specifically, when a pressure on a face seal is reduced the seal will initially only pass very small molecules of a gas present. As the pressure is further reduced liquid and/or larger molecules of the gas will begin to pass around an edge of a seal. The gas may be any gas or gasses that are trapped in a system fluid. With respect to a locomotive cooling system, the gas is generally air. In an exemplary embodiment, the gas flows between the face seals and out through a backside of the seal. A cavity, such as a seal cavity, is provided behind the seal, and is vented. For example, the gas would escape through a weep hole 60 proximate the seals.

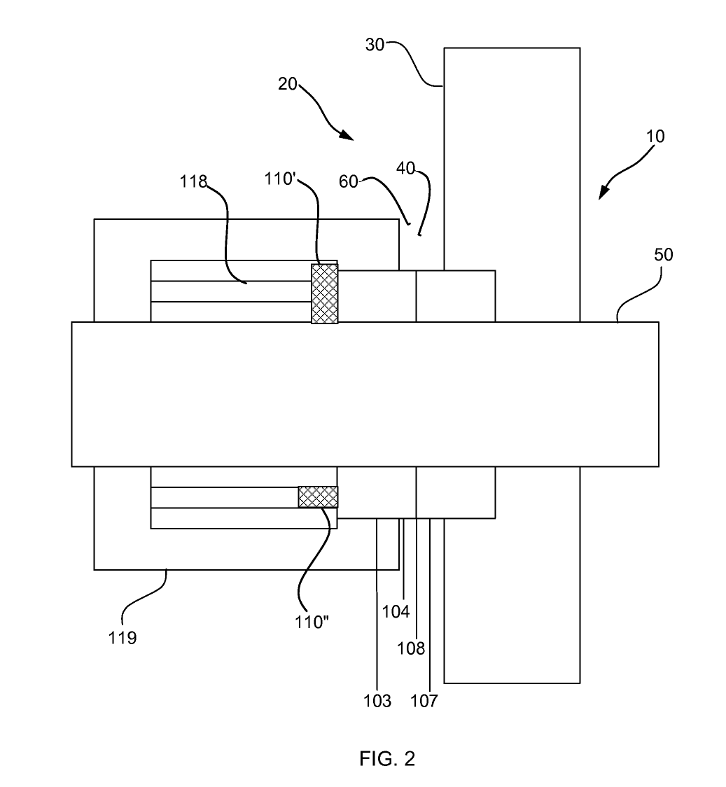

FIG. 2 depicts two other exemplary embodiments of a temperature responsive control system between two seal members. The thermally reactive element 110′ is in contact with the rotating seal 103. In one exemplary embodiment, the thermally reactive element 110′ may be a part of the spring element 118. In another exemplary embodiment, the thermally reactive element 110″ is an independent element located between the spring element 118 and the rotating seal 103 or at another location independent from the spring element 118.

Though the thermally reactive element 110 is illustrated as being in communication with either the stationary seal 107 or the rotating seal 103, in another exemplary embodiment, a first thermally reactive element is in communication with the stationary seal 107 and a second thermally reactive element is in communication with the rotating seal 103. In yet another exemplary embodiment, a single thermally reactive element may be in contact with both the stationary seal 107 and the rotating seal 103.

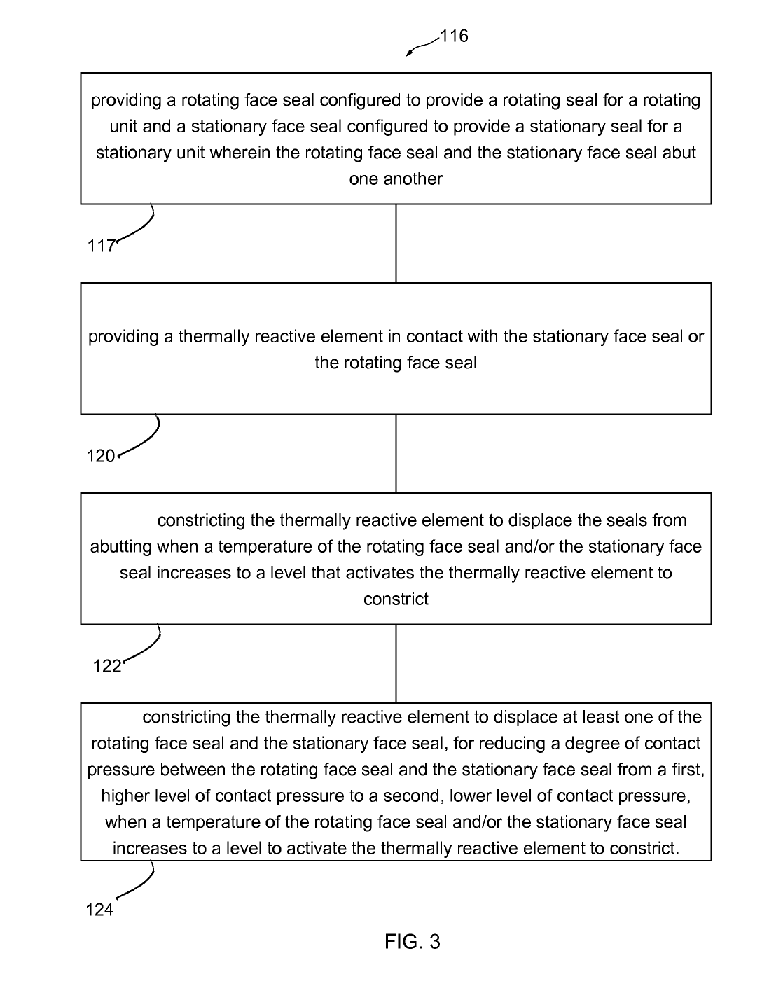

FIG. 3 depicts an exemplary embodiment of a method 116 for managing the contact between abutting seals in a system. The method 116 includes providing a rotating seal (having a rotating face seal) for a rotating unit and a stationary seal (having a stationary face seal) for a stationary unit, wherein the rotating face seal and the stationary face seal abut one another, at 117. A thermally reactive element in contact with the stationary face seal or the rotating face seal is also provided, at 120. The thermally reactive element is constricted to displace the seals from abutting when a temperature of the rotating face seal and/or the stationary face seal increases to a level that activates the thermally reactive element to constrict, at 122. The thermally reactive element is expanded to return the stationary face seal and the rotating face seal to abut one another when the temperature of the stationary face seal and/or the rotating face seal decreases below the temperature that activated the thermally reactive element to constrict, at 124.

An embodiment relates to a temperature responsive control system. The system comprises a first seal, a second seal, and a thermally reactive element. The second seal abuts the first seal. The thermally reactive element is in contact with the first seal and/or the second seal. The thermally reactive element constricts to displace at least one of the first and second seals when a temperature of the first seal and/or the second seal increases to a level to activate the thermally reactive element to constrict. In other words, above a certain temperature, the thermally reactive element constricts, and when the thermally reactive element constricts it displaces at least one of the first and second seals. Upon displacement, a degree (that is, extent or magnitude and not temperature) of contact pressure between the first and second seals is reduced from a first, higher level of contact pressure to a second, lower level of contact pressure. In an embodiment, “constricts” means changing from a first physical configuration to a second, different physical configuration. In another embodiment, the second physical configured is lessened or more compact, at least to one dimensional extent, than the first physical configuration. In another embodiment, reducing the degree of contact pressure comprises displacing the seals from abutting one another.

In an embodiment, the thermally reactive element is bi-modal, that is, it lies in a first configuration below a temperature and lies in a second configuration above that temperature. In another embodiment, the thermally reactive element is tri-modal, that is, it is in a first configuration below (or at) a first temperature, it is in a second configuration when at or between the first temperature and a second, higher temperature, and is in a third configuration when at or above the second temperature. In an embodiment, when the thermally reactive element is in the first configuration, the first and second seals lie abutted at a first level of contact pressure; when the thermally reactive element is in the second configuration the first and second seals remain abutted, but the degree of contact pressure between the first and second seals is reduced from the first level of contact pressure to a second, lower level of contact pressure; and when the thermally reactive element is in the third configuration, the first and second seals are displaced from abutting one another. The tri-modal thermally reactive element may comprise a body made from three metals with different characteristics of thermal expansion.

In an embodiment, in each of the different operational modes of the temperature responsive control system (e.g., one mode where the seals abut at a first level of contact pressure, and another mode where the degree of contact pressure is reduced), the first and second seals are positioned to prevent or at least minimize or reduce fluid leakage between the seals.

Another embodiment relates to a method for managing the contact between abutting seals in a system. The method comprises transferring heat from a seal structure to a thermally reactive element. The seal structure comprises a rotating face seal and a stationary face seal that abuts the rotating face seal. The method further comprises reacting the thermally reactive element with the transferred heat, wherein above a designated temperature the thermally reactive element changes from a first physical configuration to a second, different physical configuration. (The change between physical conditions may comprise at least part of the thermally reactive element moving from one location to another.) The method further comprises reducing a degree of contact pressure between the rotating face seal and the stationary face seal, from a first, higher level of contact pressure to a second, lower level of contact pressure, when the thermally reactive element changes from the first physical configuration to the second physical configuration. In another embodiment, the thermally reactive element changes from the second physical configuration to the first physical configuration when the temperature drops below the designated temperature, returning the degree of contact pressure between the rotating face seal and the stationary face seal back to the first, higher level.

Another embodiment relates to a temperature responsive control system for a pump seal or other seal. The pump seal or other seal comprises a rotating seal having a rotating face seal, and a stationary seal having a stationary face seal. A thermally reactive element is in operable engagement with one of the face seals. Below a designated temperature, the thermally reactive element is in a first physical condition, and maintains the two faces seals in an abutting relationship at a first contact pressure level. When the designated temperature is exceeded, the thermally reactive element changes to a second physical condition, e.g., the thermally reactive element constricts or otherwise moves. This causes the two seals to move slightly away from one another, reducing the contact pressure level between the two face seals. In an embodiment, the face seals are moved sufficiently so as to no longer abut one another.

In an embodiment, contraction and expansion of the thermally reactive element, or other change in physical configuration, involves a physical displacement or movement of at least part of the thermally reactive element that is greater than atomic excitation and thermal expansion due to temperature increase.

While the invention has been described with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated, any use of the terms first, second, etc., do not denote any order or importance, but rather the terms first, second, etc., are used to distinguish one element from another.

What is claimed is:

1. A temperature responsive control system, the system comprising:
a first seal;
a second seal abutting the first seal; and
a thermally reactive element in contact with the first seal and/or the second seal;
wherein said thermally reactive element constricts to displace at least one of said first and second seals, for reducing a degree of contact pressure between the first and second seals from a first, higher level of contact pressure to a second, lower level of contact pressure, when a temperature of the first seal and/or the second seal increases to a level to activate the thermally reactive element to constrict.

2. The system according to claim 1, wherein said thermally reactive element expands to a predefined dimension when the temperature of the first seal and/or the second seal decreases below the temperature level that activated the thermally reactive element to constrict, and wherein upon expanding the thermally reactive element returns the first and second seals to the first, higher level of contact pressure.

3. The system according to claim 1, wherein the thermally reactive element is a bi-metallic element.

4. The system according to claim 1, wherein the thermally reactive element is in contact with the first seal.

5. The system according to claim 1, wherein the thermally reactive element is in contact with the second seal.

6. The system according to claim 1, wherein the second, lower level of contact pressure results in the first seal and/or the second seal being displaced from abutting one another.

7. The system according to claim 1, wherein generation of heat is lessened when the thermally reactive element constricts which reduces the contact pressure between the first seal and the second seal.

8. The system according to claim 1, wherein when the thermally reactive element constricts, the contact pressure between the first seal and the second seal is reduced allowing a trapped non-dissolved gas to exit between the seals.

9. The system according to claim 1, wherein the system is a water pump used on a locomotive.

10. The system according to claim 1, further comprising a spring element configured to provide pressure to abut the seals.

11. The system according to claim 10, wherein the thermally reactive element is a part of the spring element.

12. The system according to claim 10, wherein said thermally reactive element is displaced between said spring element and at least one of the seals.

13. A water pump seal pressure system with abutting seals, comprising:
a rotating face seal configured to provide a rotating seal for a rotating unit;
a stationary face seal configured to provide a stationary seal for a stationary unit, wherein the rotating face seal and stationary face seal abut one another; and
a thermally reactive element in contact with the rotating face seal and/or the stationary face seal;
wherein said thermally reactive element constricts to displace at least one of the rotating face seal and stationary face seal, for reducing a degree of contact pressure between the rotating face seal and stationary face seal from a first, higher level of contact pressure to a second, lower level of contact pressure, when a temperature of the rotating seal and/or the stationary seal increases to a level to activate the thermally reactive element to constrict.

14. The water pump seal pressure system according to claim 13, wherein when the temperature between said stationary face seal and said rotating face seal decreases below the temperature that activated the thermally reactive element to constrict, said thermally reactive element expands to return said stationary face seal and said rotating face seal to abut one another.

15. The water pump seal pressure system according to claim 13, wherein the thermally reactive element is a bi-metallic element.

16. The water pump seal pressure system according to claim 13, wherein said stationary face seal or said rotating face seal are in thermal communication with said thermally reactive element such that the temperature of said stationary face seal or said rotating face seal is communicated to the thermally reactive element.

17. The water pump seal pressure system according to claim 13, wherein the water pump seal pressure system is used on a locomotive.

18. The water pump seal pressure system according to claim 13, further comprising a spring element configured to provide pressure to abut the seals.

19. The water pump seal pressure system according to claim 18, wherein the thermally reactive element is a part of the spring element.

20. The water pump seal pressure system according to claim 18, wherein said thermally reactive element is displaced between said spring element and at least one of the face seals.

21. The water pump seal pressure system according to claim 13, wherein when the thermally reactive element constricts, a contact pressure between the stationary face seal and the rotating face seal is reduced allowing a trapped non-dissolved gas to exit between the face seals.

22. A method for managing the contact between abutting seals in a system, the method comprising:
providing a rotating face seal configured to provide a rotating seal for a rotating unit and a stationary face seal configured to provide a stationary seal for a stationary unit wherein said rotating face seal and said stationary face seal abut one another;
providing a thermally reactive element in contact with said stationary face seal or said rotating face seal;
constricting the thermally reactive element to displace said seals from abutting when a temperature of the rotating face seal and/or the stationary face seal increases to a level that activates the thermally reactive element to constrict; and
constricting the thermally reactive element to displace at least one of the rotating face seal and the stationary face seal, for reducing a degree of contact pressure between the rotating face seal and the stationary face seal from a first, higher level of contact pressure to a second, lower level of contact pressure, when a temperature of the rotating face seal and/or the stationary face seal increases to a level to activate the thermally reactive element to constrict.

23. The method according to claim 22, further comprising expanding the thermally reactive element to return said stationary face seal and said rotating face seal to abut one another when the temperature of said stationary face seal and/or said rotating face seal decreases below the temperature that activated the thermally reactive element to constrict.

24. The method according to claim 22, further comprising allowing a non-dissolved gas to exit between the rotating face seal and the stationary face seal when the thermally reactive element constricts to reduce a contact pressure between the stationary face seal and the rotating face seal.
